(19) United States
(12) Patent Application Publication
(10) Pub. No.: US 2025/0208575 A1
(43) Pub. Date: Jun. 26, 2025

(54) HOROLOGICAL MOVEMENT PROVIDED WITH A MECHANISM FOR DRIVING A JUMPING INDICATOR

(71) Applicant: ETA SA Manufacture Horlogère Suisse, Grenchen (CH)

(72) Inventors: Théo PENNINO, Nidau (CH); Stéphane BACHMANN, Büren an der Aare (CH)

(73) Assignee: ETA SA Manufacture Horlogère Suisse, Grenchen (CH)

(21) Appl. No.: 18/942,881

(22) Filed: Nov. 11, 2024

(30) Foreign Application Priority Data
Dec. 21, 2023 (EP) 23219465.4

(51) Int. Cl. G04B 19/253

(52) U.S. Cl. CPC G04B 19/25353

(57) ABSTRACT

A horological movement provided with an indicator and includes a mechanism for driving this indicator in jumps, the mechanism including a wheel platform, a rigid part defining a driving finger, and a spring having a first end attached to the wheel platform for rotation therewith and a second end attached to the rigid part for rotation therewith. The mechanism is arranged so that the spring contracts when this spring is loaded to generate a jump by the indicator. An angular displacement of the driving finger relative to the wheel platform is then limited, when the spring is contracted, by an angular stop attached to the wheel platform for rotation therewith. The indicator and the mechanism are arranged so that a jump by the indicator cannot occur, in normal operation, before the angular displacement is stopped by the angular stop, after a loading of the spring preceding this jump, and thus corresponds to a predetermined angular distance (α).

### TECHNICAL FIELD OF THE INVENTION

The present invention relates to a horological movement provided with an indicator and comprising a mechanism for driving this indicator in jumps, and further relates to a watch incorporating a horological movement provided with such a mechanism. In particular, the indicator is a date indicator.

### TECHNOLOGICAL BACKGROUND

Patent document EP 3828644 describes a mechanism for driving a jumping indicator which advantageously overcomes technical problems of the prior art by comprising a rigid drum-finger, guided rotatably and translatably by a hub passing through an oblong hole in the drum, and a spring arranged in this drum-finger and connecting the latter to a wheel platform.

This drive mechanism has a number of drawbacks. Firstly, the spring expands when the date ring is driven and its coil is intended to bear against the interior wall of the drum when the spring is being loaded, so as to limit the expansion of the spring and prevent it from reaching the plastic range of the spring. This results in a sudden reduction in the active length of the spring. Given the manufacturing tolerances of the various components, the loading time of the drive mechanism can vary, as the time at which the spring comes into contact with the interior wall of the drum can vary from one loading to the next and the angular position of the contact zone can also vary. This leads to an inaccuracy in the time at which the ring is triggered to move on to the next date. Another problem arises from the fact that the driving force is transmitted to the finger via the coil of the spring, which must thus have sufficient rigidity/stiffness over its entire length and more particularly over the portion located between the contact zone with the wall of the drum and the coupling member for coupling with this drum, which is arranged at the second end of the spring, this portion ultimately having to withstand the entire additional torque generated from the moment of contact up to the moment when the indicator makes a jump.

The figures in the above-mentioned document show that the coupling member of the spring is arranged in a shallow recess from which this member can easily emerge. The two lateral surfaces of the recess are parallel in a radial direction passing through the middle of the recess and the coupling member has two radial flanks, the angular width of the coupling member being less than that of the recess to allow this member to penetrate easily into the recess. Moreover, the coupling member is intended to have a large amount of play in the recess, to allow this coupling member to move in the recess. Thus, a relatively small impact can easily result in the coupling member coming out of its recess. If this is the case, either when the spring is loaded bearing against a tooth of the date ring, or before loading this spring, which then typically exhibits slight expansion due to the friction exerted on the drum, the coupling member exits from the side of the finger radial driving flank. In this situation, the lateral wall of the drum exerts a radial force on the coupling member such that it is subjected to a frictional force on this lateral wall. If the coupling element comes out of its recess when the spring bearing against a tooth of the date ring is loaded, either it then slides along the inner lateral surface and the date jump will not occur until at least the drive wheel has made one revolution and the coupling element re-enters its recess (the best case scenario, which nonetheless results in the loss of a correct date display, which has missed a daily jump), or the frictional force is sufficient for the spring to expand again, further increasing the frictional force, until its coil touches the lateral wall and a date jump takes place at an indeterminate time. In the latter case, after the date jump, the spring will relax by driving the drum. If this situation recurs, the next date changes will no longer occur around midnight. If the coupling element undergoes a certain sudden angular displacement along the lateral wall, which is likely, then this situation will be repeated for at least a few days with date increments at indeterminate and variable times. In any event, the date drive mechanism will stop being functional for at least several days as soon as the coupling member is out of its recess, which event is highly probable for the mechanism as shown in the figures of patent document EP 3828644.

The geometry of the coupling member in relation to its recess, allowing a large amount of play and a certain mobility of the coupling member in the recess, creates another problem. More specifically, when the spring is loaded, it will deform the coil of the spring and cause the coupling member to rotate about itself. This rotation will cause the coupling member to slide against the front lateral wall of the recess such that the point of application of the force from the spring on the drum-finger is reduced radially as the spring is loaded. Thus, for a given level of spring loading, the driving torque provided by the spring on the finger decreases in proportion to the decrease in the application, by the lever arm, of the force from the spring on the drum-finger, which poses a problem because the driving force of the finger on the tooth of the indicator decreases in the same proportion for a given contact point. Since a given driving torque is required to make the indicator jump, the spring will have to generate a force that is all the greater since said lever arm decreases during the loading of the spring, which has a negative impact on the performance of the horological movement that loads the spring of the driving mechanism and must thus provide more torque. This also requires the spring to be more robustly dimensioned than necessary.

Finally, another problem with the mechanism in question arises from the fact that, when the indicator is driven, the coil of the spring exerts a radial force on the drum directed outwards in an area diametrically opposite the finger and thus substantially in the longitudinal direction of the oblong hole, which tends to move this finger away from the toothing of the ring. The finger is thus more likely to pass a tooth without the indicator being driven, particularly in the event of a small impact in such a situation. It should also be noted that such a situation reduces the angular path over which the finger can drive a tooth by remaining in contact, so that it is possible for the finger to pass the tooth before it receives a driving torque over an angular distance sufficient to ensure a jump in the date, the date ring remaining stationary in an intermediate position or returning back to its previous stable position once the finger has passed the tooth. Furthermore, reducing the lever arm for applying the driving force to the tooth requires, for a given driving torque, an increase in the drive force required, which requires the force supplied by the spring and thus its tension to also be increased.

### SUMMARY OF THE INVENTION

The purpose of the invention is to provide a mechanism for driving a jumping indicator, which mechanism does not have the drawbacks of the prior art described above. The invention further aims to provide a horological movement provided with an indicator and comprising a mechanism for driving this indicator in jumps, which mechanism is efficient, which can be precise in each horological movement comprising such a mechanism, and whose operation is little or not at all disturbed by external stresses, for example by impacts.

To this end, the invention relates to a horological movement provided with an indicator and comprising a mechanism for driving this indicator in jumps, the mechanism comprising a wheel platform defining an axis of rotation, a rigid part arranged above the wheel platform and defining a driving finger for driving the indicator, and a spring formed by a first end, a coil and a second end, the first end being attached to the wheel platform for rotation therewith and the second end being attached to the rigid part for rotation therewith at least during each loading of the spring preceding a jump by the indicator and the driving of the indicator by the mechanism during this jump. The rigid part can rotate relative to the wheel platform and is guided rotatably about said axis of rotation by a shaft passing through an opening in this rigid part and which allows the driving finger to retract towards the axis of rotation under the action of a radial component of a force exerted on this driving finger. The mechanism is arranged in such a way that the spring contracts when this spring is loaded in order to be able to cause the indicator to jump, and in such a way that an angular displacement of the second end of the spring, and thus of the driving finger, relative to the wheel platform, and thus to the first end of the spring, is limited, when the coil is contracted, by an angular stop attached to the wheel platform for rotation therewith.

In a preferred embodiment, the indicator and the mechanism are arranged so that each jump by the indicator occurs, in normal operation, after said angular displacement has been stopped by the angular stop, once a loading of the spring preceding this jump has ended, and thus corresponds to a determined angular distance (from the angular position in which the spring is not angularly stressed).

Thanks to the features of the invention, in order to drive the indicator in jumps, the coil of the spring contracts over its entire length for the duration of the loading of the spring in order to cause the indicator to jump and thus increment this indicator. The coil of the spring is left free to expand for the duration of the loading. Firstly, this is much less critical, for the dimensions of the spring and the features of the material forming it, than expansion where only part of the coil is active in a terminal phase of spring loading. Thereafter, the duration of the loading of the spring, up to a given force couple to cause the indicator to jump, depends solely on the spring itself, in particular its stiffness. As long as the spring remains in its initial state and in particular with an unchanging stiffness, the angular displacement between the two ends of the spring remains unchanging from one loading to the next, so that the duration of the loading remains unchanging for each loading of the spring and thus each jump occurs at a given time which remains very precise. Moreover, by contracting the spring, a constant radius can be obtained for applying the driving force of the finger to the indicator tooth against which the finger bears, thereby optimising this driving force and thus the driving torque required to cause the indicator to jump. Finally, thanks to the spring contracting, a wall around the periphery of the spring is not needed, the function of which wall would be to limit the expansion of the coil of the spring as well as to greatly increase the force couple applied to the finger to cause the indicator to jump. Thus, the present invention does not require a drum-finger, although a drum-finger is provided in a particular alternative embodiment.

The present invention is also characterised by the arrangement of an angular stop integral with the wheel platform, which stop limits the angular displacement of the second end of the spring, relative to its first end, to a predetermined unchanging angular distance, so as to prevent the spring from leaving its resilient range and thus prevent the spring from deteriorating. In the above-mentioned preferred embodiment, the angular stop is arranged so that, in normal operation, the indicator does not jump before a part integral with the second end of the spring or this second end comes to bear against the angular stop. Thus, each time the spring is loaded, the drive mechanism has the same relative angular displacement between the driving finger and the wheel platform, this relative angular displacement being defined not by the stiffness of the spring but by the angular stop. In an advantageous alternative embodiment, the spring and the angular stop are part of the same component.

According to another advantageous embodiment, the rigid part is formed by a plate, which extends above the spring and in which said opening is machined, and an axial wall arranged at the edge of this plate and which slopes down towards the wheel, on which it can rest. The axial wall and a part of the plate, which is stacked thereon, jointly form the driving finger, which has a height that extends at least from the underside of the spring to the upper surface of the plate. The axial wall has a recess with a lateral opening on the spring side. The second end of the spring is extended by a member for coupling to the rigid part, this coupling member being configured so that, when the spring is assembled with the rigid part, it can penetrate at least partially into the recess and, once in place, allow the spring to apply a driving force couple to the rigid part.

In an advantageous alternative embodiment, the coupling member and the recess are configured so that the contact point or contact zone of the recess, on which point or zone the spring force is exerted, via the coupling member, does not substantially vary when the spring is being loaded. The term ‘substantially’ indicates that a slight variation may occur in a short initial phase of spring loading. In particular, the point or zone of application of the force of the spring on the rigid part, via the coupling member, does not move substantially towards the centre of rotation, in particular by a radial sliding of the coupling member or by rotation thereof about itself. To this end, in a particular alternative embodiment, the recess has a lateral surface oriented obliquely in the direction of rotation of the wheel platform, in which direction the indicator is intended to be driven, relative to a radial direction, in the spring loading configuration, passing through the centre of this lateral surface, and the coupling member has a lateral flank, facing the lateral surface, which is also inclined obliquely, relative to a radial direction defined by the axis of rotation, in the same direction as the lateral surface and which bears at least partially against this lateral surface when the spring is loaded and the indicator is driven during its next jump.

In a preferred embodiment, the coupling member and the recess are configured such that the coupling member cannot substantially rotate about itself, in the direction of rotation of the wheel platform, when the spring is being loaded. The term ‘substantially’ indicates that a slight rotation may occur in a short initial phase of spring loading. To this end, the coupling member advantageously has a rear heel for blocking rotation of the coupling member about itself in said direction of rotation of the wheel platform. This feature combined with the configurations of the recess and of the coupling member, in the particular alternative embodiment mentioned above, is effective in preventing any rotation of the coupling member about itself in the direction of rotation of the wheel platform, and thus in preventing the point of application of the force of the spring on the rigid part fitted with the finger from varying, in particular from decreasing. The driving torque of the finger is thus kept constant for a given force applied by the spring. This property improves the efficiency of the drive mechanism because the conversion of the energy stored in the spring into drive torque for driving the finger on the indicator is directly proportional to the radius of application of the force of the spring on the rigid part. Thus, for a driving force required to cause the given indicator to jump, the mechanism described here does not need to compensate for the loss of leverage by additional torque. It should be noted that the mechanical energy consumed by the drive mechanism, taken from the horological movement, has a direct influence on its performance.

### BRIEF DESCRIPTION OF THE FIGURES

The aims, advantages and features of the invention will be described in greater detail below with the aid of the accompanying drawings, which are given by way of non-limiting examples, in which:

FIG. 1 is a top view of a timepiece mechanism, according to a first embodiment of the invention, which mechanism is intended to drive a jumping indicator, in particular in semi-instantaneous jumps;

FIG. 2 is an exploded, perspective view of the timepiece mechanism in FIG. 1;

FIG. 3 is a perspective view of the drum-finger and of the spring of the timepiece mechanism in FIG. 1, shown in an inverted position;

FIG. 4 is a view, similar to FIG. 3, of the drum-finger and of the spring of the timepiece mechanism according to a second embodiment of the invention;

FIG. 5 is a view, similar to FIG. 3, of the drum-finger and of the spring of the timepiece mechanism according to a third embodiment of the invention;

FIG. 6A to 6D partially show a horological movement according to the first embodiment, respectively in four successive states occurring when a date ring is being driven by the drive mechanism;

FIG. 7A and 7B partially show the horological movement in FIG. 6A in two successive states respectively, which states occur when the date ring is driven rapidly, by a conventional control member, in the date ring drive direction;

FIG. 8A and 8B partially show the horological movement in FIG. 6A in two successive states respectively, which states occur when the time display hands are driven in a counter-clockwise direction and thus the wheel platform is driven in the opposite direction to the drive direction of this platform when the date ring is driven.

### DETAILED DESCRIPTION OF THE INVENTION

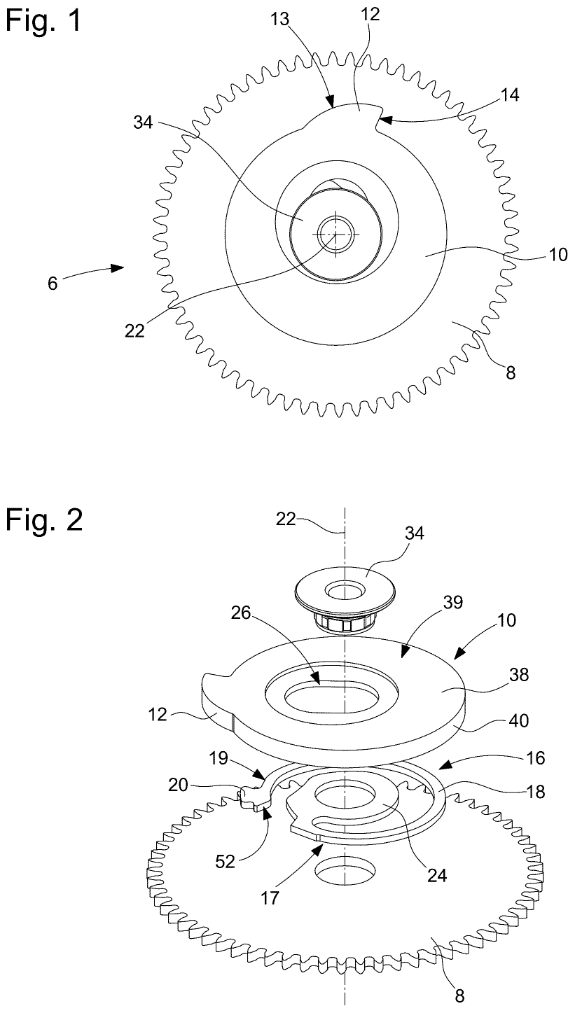

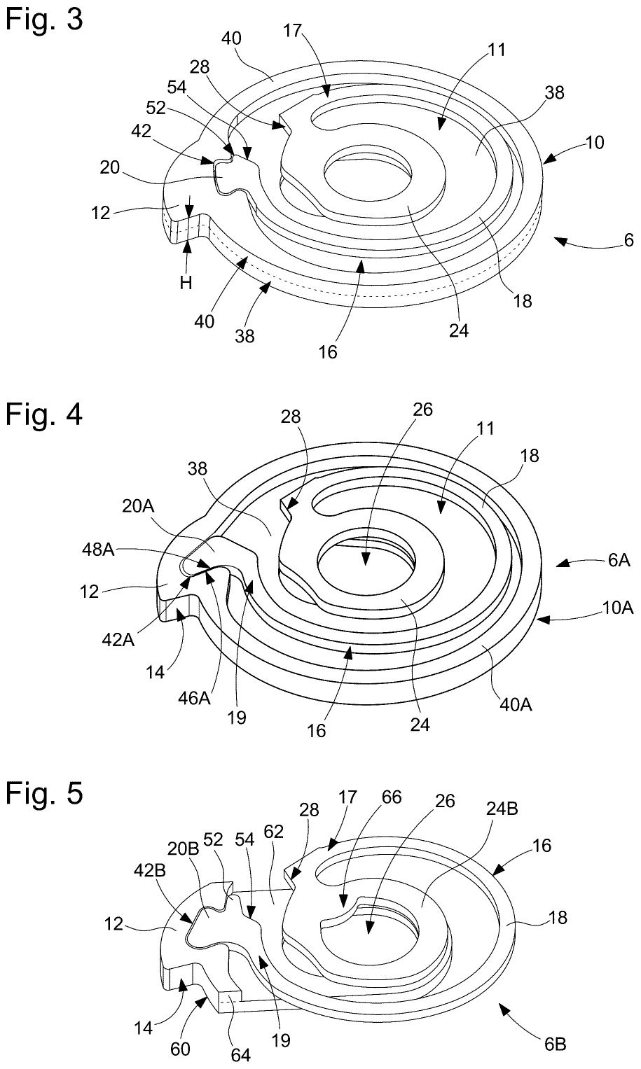

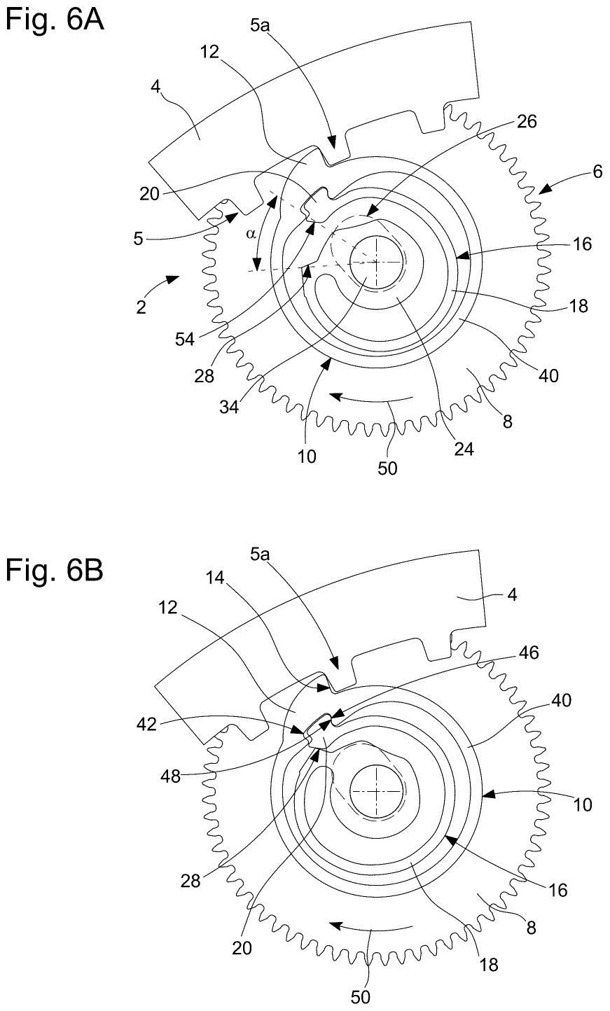

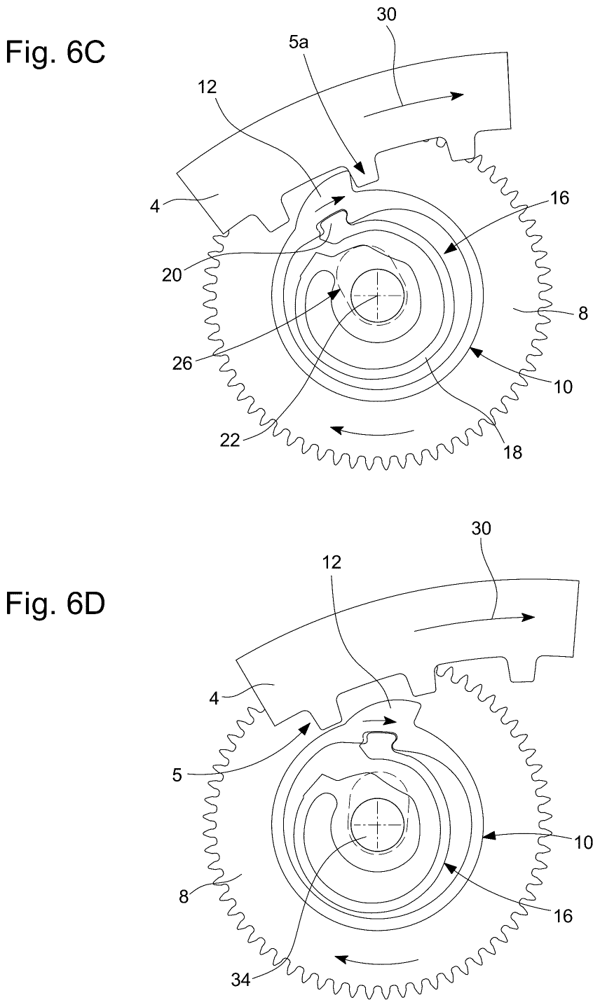

With reference to FIGS. 1 to 3, a first, preferred embodiment of a mechanism for driving an indicator in jumps, in particular in semi-instantaneous jumps, will be described, and with reference to FIG. 6A to 8B, the operation of a horological movement according to the invention incorporating such a drive mechanism will be described. The jumping indicator is, for example, a minute indicator, hour indicator, date indicator, day indicator or month indicator.

The mechanism 6 for driving a jumping indicator, in particular a date ring 4, comprises a wheel platform 8 having an axis of rotation 22, a rigid part 10 arranged above the wheel platform and defining a driving finger 12 for driving the indicator, and a spring 16 formed by a first end 17, a coil 18 and a second end 19. The rigid part 10 can rotate relative to the wheel platform 8 and is guided rotatably about the axis of rotation 22 by a shaft passing through an opening 26 in this rigid part. In the alternative embodiment, which is shown by way of a non-limiting example, the opening defines an oblong hole (hereinafter referred to as an oblong hole 26). Typically speaking, the first end 17 is attached to the wheel platform 8 for rotation therewith and the second end 19 is attached to the rigid part for rotation therewith, at least each time the spring is loaded preceding a jump by the indicator and when the indicator is driven by the mechanism during this jump. In a main alternative embodiment, the indicator is a date indicator, in particular a date ring. The first end 17 of the spring 16 is connected to a central part 24 which is attached to the wheel platform 8 for rotation therewith. Preferably, the spring and the central part form one and the same part. The mechanism 6 comprises a central hub 34 defining a shaft which passes through the oblong hole 26 in the rigid part 10 and guides this rigid part rotatably and translatably relative to the wheel platform 8, the latter and the central part 24 being driven onto the central hub 34. The driving finger 12 has a substantially radial drive flank 14 and an outer flank 13 which is arcuate and whose slope decreases progressively, relative to a direction perpendicular to the radius, as it approaches the drive flank.

The rigid part 10 is formed by a plate 38, which extends above the spring and in which an oblong hole 26 is machined, and an axial wall 40 arranged at the edge of this plate and which slopes down towards the wheel platform, on which it can rest in one alternative embodiment. A part of the axial wall 40 and a part of the plate 38, which is stacked thereon, jointly form the driving finger 12, which has a height H that extends at least from the underside of the spring 16 to the upper surface 39 of the plate. The rigid part 10 thus forms a drum-finger defining an interior space 11 in which the spring is arranged.

The axial wall 40 has, at the driving finger 12, a recess 42 which has a lateral opening on the side of the spring 16. The second end 19 of the spring is extended by a member 20 for coupling to the rigid part 10, this coupling member 20 being configured so that it can penetrate at least partially into the recess and thus allow the spring to apply a driving force couple to the rigid part 10. In particular, the coupling member is rigid.

In the first embodiment, the coupling member is configured so as to be able to penetrate at least partially into the recess through the lateral opening. Moreover, the recess 42 advantageously has a lateral surface 46 oriented obliquely in the direction of rotation 50 of the wheel platform 8, in which direction the indicator 4 is intended to be driven, relative to a radial direction, in the configuration for loading the spring, passing through the centre of the lateral surface, and the coupling member 20 has a lateral flank 48, facing the lateral surface, which is also inclined obliquely in the same direction as the lateral surface and which bears at least partially against the lateral surface each time the spring 16 is loaded for driving the jumping indicator using the mechanism 6. This particular feature ensures that the coupling member is held precisely in a given drive position inside the recess as soon as the spring is tensioned during loading. In other words, the contact point or contact zone of the recess 42, on which point or zone the spring force is exerted, via the coupling member 20, substantially does not vary when the spring is being loaded. Only a slight variation may occur in a short initial phase of spring loading.

Advantageously, the coupling member and the recess are configured such that the coupling member 20 cannot substantially rotate about itself, in the direction of rotation of the wheel platform, when the spring is being loaded. Only a slight rotation may occur in a short initial phase of spring loading. According to a particular feature, the coupling member 20 has, for this purpose, a rear heel 52 intended to prevent rotation of the coupling member about itself, once in position in the recess 42, in the direction of rotation 50 of the wheel platform (direction of rotation intended for driving the indicator). This rear heel is extended by a contact surface 54 which comes to bear against the angular stop 28 at the end of the loading of the spring, to then cause the indicator to jump. Preferably, the angular stop 28 is located between the first end 17 of the spring and the rigid ring 24, in the angular extension of the coil 18 of the spring, and is defined by one and the same part forming the rigid ring and the spring.

Once the coupling member 20 has been assembled to the drum-finger 10, without any external stresses and in particular without any impact, this coupling member remains coupled to the drum-finger at all times, whatever the state of the mechanism, i.e. in a non-angularly stressed state of the spring in periods when there is no interaction between the toothing 5 of the indicator 4 and the driving finger 12, in a state in which the spring works in contraction when it is loaded before the indicator jumps, when the indicator jumps, and also when the spring is stressed in expansion, in particular when the wheel platform 8 is rotated in the direction opposite to the intended direction for driving the indicator 4, in order to correct the time in a counter-clockwise direction. In conclusion, during normal operation of the horological movement, the coupling member 20 remains coupled to the drum-finger as intended, i.e. in place in the recess 42, and thus integral with the drum-finger.

Remarkably, the mechanism 6 is arranged in such a way that, if the coupling member 20 happens to come out of the recess 42 during an impact, this coupling member cannot move in the direction of rotation 50 of the wheel platform 8 beyond this recess, whatever the state in which the mechanism is before such an impact. In the event of an impact generating a force on the coupling member that could result in this coupling member leaving its recess, which is highly unlikely, the spring is then in a state that allows the coupling member to be returned to the recess. The rigid part and the coupling member are arranged in such a way that, if the coupling member 20 is located upstream of the recess 42 relative to the direction in which the wheel platform is driven, the driving of the spring by the wheel platform returns the coupling member to the recess after the driving finger 12 has come to bear against a tooth 5a of the indicator 4, in order to make the next scheduled jump, and before this next indicator jump occurs, so that no jump made by this indicator is missed, with the indicator thus continuing to display correct information.

In an advantageous alternative embodiment, the recess 42 has a minimum dimension on the side of its opening which is slightly smaller than a maximum dimension of the coupling member perpendicular to the radial direction, relative to the axis of rotation 22 (coincident with the central axis of the rigid ring 24), of the spring in an angularly relaxed state. More typically, the coupling member and the recess are arranged in such a way that the coupling member cannot emerge from the recess by undergoing at least one translation relative to the rigid part, i.e. without undergoing at least one rotation about itself (rotation about its geometric centre about an axis parallel to the axis of rotation 22). To enter the recess through the lateral opening, the coupling member must thus rotate slightly about itself. This specific feature ensures that once the coupling member has been properly inserted into the recess 42 and is thus in position, there is very little risk of it coming out of the recess, although this is not impossible in exceptional cases in the event of specific impacts.

FIG. 4 shows a mechanism 6A for driving an indicator in jumps according to a second embodiment of the invention. This mechanism 6A differs essentially from that of the first embodiment in that the coupling member 20A has a different shape and the profile of the recess 42A intended to receive it is also different. The recess 42A, arranged in the lateral wall 40A of the drum-finger 10A, has an overall triangular shape and opens progressively towards the interior space 11 of the drum-finger 10A in which the spring 16 is arranged. The shape of the part of the coupling member 20A which is inserted into the recess through the lateral opening corresponds substantially to that of the recess. This configuration allows the coupling member to be inserted easily into the recess, but would a priori allow this member to come out in the event of an impact, even though the recess is intended to be relatively deep, without other means being provided to prevent such an event. The means provided here to best maintain the coupling member in the recess, particularly in the event of an impact, are the shape of the inner part of the coupling member and the shape of the central part 24 as well as the relative arrangement of this inner part and of this central part. In most possible situations, the inner part of the coupling member abuts against the central part 24 before the coupling member fully emerges from the recess. Moreover, the coupling member 20A is substantially aligned with the longitudinal axis of the oblong hole 26 such that, when it undergoes a substantially radial acceleration and in particular along the longitudinal axis of the recess 42A towards the axis of rotation, the more solid drum-finger 10A undergoes the same radial movement in the same direction, which tends to hold the coupling member in the recess.

In this second embodiment, once inserted into its recess 42A, the coupling member 20A is held in place in its recess by a radial force exerted by the spring against the lateral wall 40A of the drum-finger 10A. This radial force is increased during a rapid change of the date or during a counter-clockwise time correction passing through midnight, by the fact that the driving finger then retracts towards the axis of rotation 22 via a radial displacement of the drum-finger, such that the coupling member normally remains in the recess even when the spring 16 is forced to expand in these situations, given that the drum-finger undergoes a rotation relative to the wheel platform 8 in a direction opposite to the relative direction of rotation of this drum-finger that occurs when the date ring is driven by the mechanism 6A. Preferably, as in the first embodiment, the recess 42A advantageously has a lateral surface 46A oriented obliquely in the normal direction of rotation of the wheel platform, in which direction the indicator is intended to be driven, relative to a radial direction, in the spring loading configuration, passing through the centre of this lateral surface, and the coupling member 20A has a lateral flank 48A, facing the lateral surface, which is also inclined obliquely, relative to the axis of rotation 22, in the same direction as the lateral surface and which bears at least partially against this lateral surface each time the indicator is driven by the mechanism. The lateral surface and the lateral flank are relatively long. This particular feature ensures that the coupling member is held securely in the recess as soon as the spring 16 is contracted. In particular, the contact point or contact zone of the recess, on which point or zone the spring force is exerted, via the coupling member, does not vary when the spring is being loaded. Moreover, the coupling member 20A cannot rotate about itself, in the direction of rotation of the wheel platform, when the spring is being loaded.

FIG. 5 shows a mechanism 6B for driving an indicator in jumps according to a third embodiment of the invention, which embodiment differs from the previous embodiments firstly in that the coupling member 20B is inserted into a recess 42B from which it cannot emerge via the lateral opening. The corollary of this feature relates to the assembly of the spring 16 to the rigid part 60, with the coupling part 20B in this case having to be inserted axially into the recess 42B. The coupling member has a rear heel 52 and a contact surface 54 intended to come to bear against the angular stop 28 when the loading of the spring ends and before the indicator jumps. Secondly, the mechanism 6B differs from that of the previous embodiments in that the rigid part 60 does not form a drum-finger, this rigid part being formed by an elongate plate 62 having, at a first end, the oblong hole 26 and, at the second end, a lateral wall 64 which lowers (or rises depending on the spatial position of this part) from the elongate plate, and the major part of which forms the driving finger 12. It should be noted that the central part 24B, to which the first end 17 of the spring 16 is connected, is not driven onto the central hub (not shown) but has an internal projection 66 which fits into a recess in the central hub so as to be attached to the wheel platform for rotation therewith.

Subsequently, reference is made back to the first embodiment, which is preferred, in order to show in more detail, using FIG. 6A to 8B, the operation of the horological movement 2, in particular the mechanism 6 for driving a date ring 4. It should be noted that in FIG. 6A to 8B, the plate 38 of the drum-finger 10 is not shown in order to better illustrate the elements located in the interior space 11 of the drum-finger.

The rigid part 10 can rotate relative to the wheel platform 8 and is guided rotatably about the axis of rotation 22 by a shaft, formed by the hub 34, passing through the oblong hole 26, which allows the driving finger to retract towards the axis of rotation under the action of the interaction between the toothing 5 of the indicator 4 and the outer flank 13, which generates a progressively radial force. Such retraction is useful for allowing the driving finger 12 to retract during rapid correction of the date ring 4 in the direction of rotation 30 of this indicator (normal direction of rotation in which this indicator is intended to be driven each time by the mechanism 6) or during a counter-clockwise correction of the time, as well as in the event of the finger abutting against the upper flank of the toothing 5 in the case of incorrect indexing of the indicator. The mechanism is arranged so that the spring 16 contracts when this spring is loaded in order to be able to generate a jump, in particular a semi-instantaneous jump of the indicator. Moreover, an angular displacement of the second end 19 of the spring, and thus of the driving finger 12, relative to the wheel platform 8, and thus to the first end 17 of the spring, is limited, when the coil 18 contracts as a result of the loading of the spring, by an angular stop 28 attached to the wheel platform 8 for rotation therewith. Preferably, the indicator and the mechanism are arranged so that, in normal operation, a jump by the indicator occurs after the angular displacement has been stopped by the angular stop 28, once a loading of the spring preceding this jump has ended, and thus corresponds to an angular distance a determined by the angular stop. It should be noted that in an advantageous embodiment, in normal operation, a jump by the indicator occurs before the angular displacement has been stopped by the angular stop 28. In such a case, the angular stop is a spring protection stop.

In a general embodiment, the drive mechanism does not have any angular stop. The spring contracts and the coil of this spring remains free to expand between the two ends of the spring during loading periods.

FIG. 6A to 6D show four successive states of the mechanism 6 for driving the date ring 4 in jumps, in particular in semi-instantaneous jumps. FIG. 6A to 6D show the mechanism 6 and the date ring 4, when this ring is driven in order to change to a next date at midnight, respectively:—At the time when the driving finger 12 comes into contact with a tooth 5a of the ring 4 and the spring 16 is substantially angularly relaxed (i.e. not angularly stressed);—once the loading of the spring 16 ends when the contact surface 54 of the coupling member 20 comes to rest against the angular stop 28 after having undergone the angular displacement a relative to the wheel platform 8;—during the date jump generated by the mechanical energy stored in the contracted spring being applied to this drum-finger;—at the end of the jump, when the date ring has substantially reached its next stable position.

It should be noted that, in order to prevent a tooth 5a of the indicator 4 from passing over or under the driving finger 12 when the indicator is driven, it is provided that the height between the wheel platform 8 and the underside of the toothing 5, including play, remains constantly between the lower height and the upper height of the driving finger from the wheel platform, including play. To this end, in an advantageous alternative embodiment, the lower height of the finger is smaller than the thickness of the teeth of the toothing 5. Preferably, in a watch incorporating the horological movement 2, the distance between the upper height of the finger and a dial covering the drive mechanism and the indicator is also designed to be smaller than the thickness of the teeth of the toothing 5. The large height of the finger 12, which can rise at least from the underside of the spring 16 to above the plate 38 which defines the upper surface of the mechanism 6, makes it easy to prevent a tooth 5a passing under or over the finger 12.

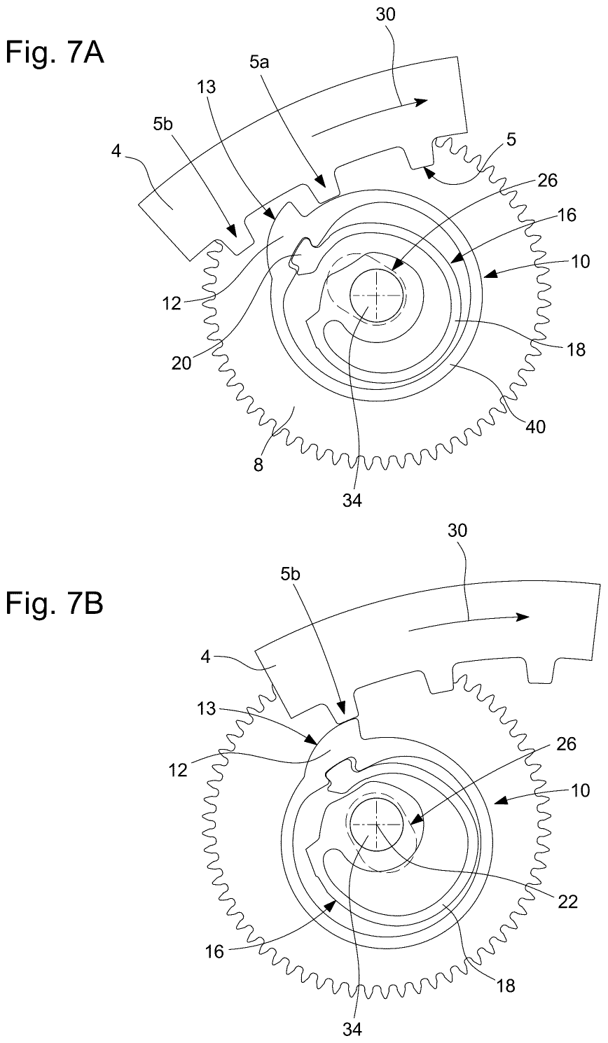

FIG. 7A and 7B show the behaviour of the mechanism 6 during rapid correction of the date ring 4, by means of a control member that can be operated by a user in the conventional way, in the evening in which the wheel platform 8 and the drum-finger 10 are for example initially in the configuration shown in FIG. 7A, so that the finger 12 is located between the tooth 5a and the tooth 5b that precedes it relative to the direction of rotation 30, so that the finger 12 is in the path of the tooth 5b of the indicator. The ring 4 is intended to advance rapidly in the direction of rotation 30 corresponding to the single direction of in which the date ring is driven. As shown in FIG. 7B, the tooth 5b of the toothing 5 comes into contact with the arcuate outer flank 13 of the finger 12 when the ring 4 is rotated, and then exerts a progressively radial force on this finger, which moves the drum-finger 10, thanks to the presence of the oblong hole 26, the longitudinal axis of which is substantially aligned with the finger, so that the finger retracts towards the central hub and thus towards the axis of rotation 22. Thus, the finger 12 retracts, allowing the tooth 5b to follow the outer flank 13 of the finger until this tooth protrudes angularly beyond the finger. During radial displacement of the drum-finger, the spring contracts radially and the coupling member 20 moves closer to the central hub and to the central part 24, which has a flared cavity intended to receive an inner part of the coupling member 20 when it approaches this central part during rapid correction of the date ring. It should be noted that the spring 16, more precisely its coil 18, is also expanded during the rapid correction of the date ring, simultaneously with the radial stress to which the spring is subjected towards the axis of rotation of the wheel platform.

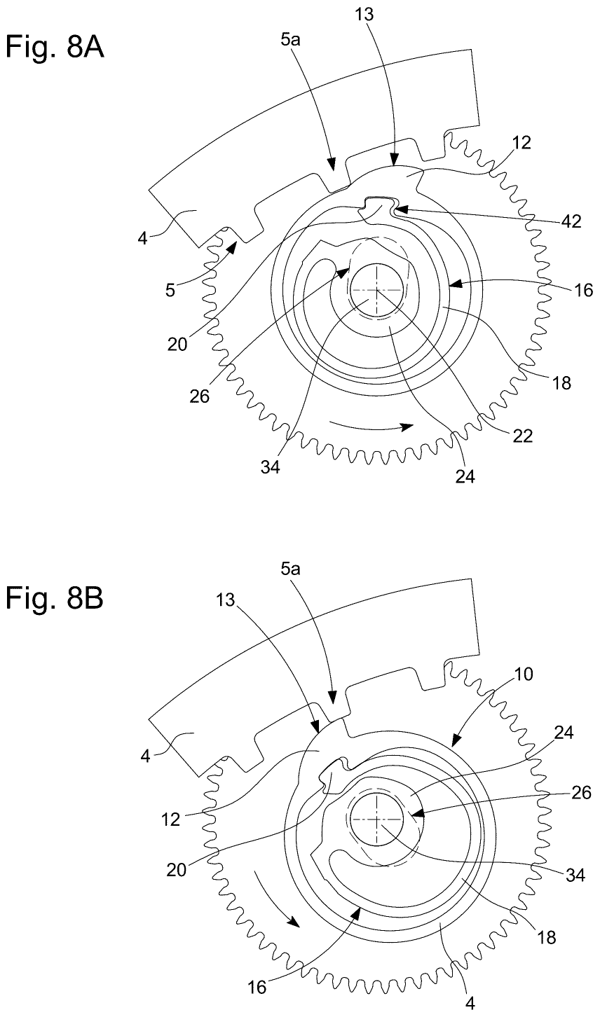

FIG. 8A and 8B show the behaviour of the mechanism 6 during a correction of a time displayed by the timepiece mechanism, which rotates the wheel platform 8 in a counter-clockwise direction through midnight. In this case, the date ring 5 remains stationary in the stable position in which it was when the time was corrected. The succession of states of the mechanism 6 is similar to that which takes place during the rapid correction of the date display described above. When the wheel platform 8 and thus the drum-finger 10 rotate in a direction opposite to the normal direction of rotation 50 (corresponding to the clockwise direction of the time display), the arcuate outer flank 13 of the finger 12 comes to bear against a tooth 5a of the toothing 5 (FIG. 8A) and the drum-finger continues to rotate, however more slowly than the wheel platform, while the driving finger moves radially towards the axis of rotation 22, so that this finger retracts while the unmoving tooth runs along the outer flank 13 of the finger. Once again, the spring 16 is forced to expand during such a correction.

The mechanism 6 is configured to prevent blocking during rapid date correction or counter-clockwise time correction.

The invention further relates to a watch comprising a horological movement 2 according to the invention, which movement is incorporated into a case, this case also incorporating a dial arranged in such a way as to allow the display of an item of data that changes over time by way of jumps, in 10 particular the date display.

1. A horological movement provided with an indicator and comprising a mechanism for driving said indicator in jumps, the mechanism comprising a wheel platform defining an axis of rotation, a rigid part arranged above the wheel platform and defining a driving finger for driving the indicator, and a spring formed by a first end, a coil and a second end, the first end being attached to the wheel platform for rotation therewith and the second end being attached to the rigid part for rotation therewith, at least each time the spring is loaded preceding a jump by the indicator and when the indicator is driven by the mechanism during said jump, the rigid part being rotatable relative to the wheel platform and rotatably guided about said axis of rotation by a shaft passing through an opening in said rigid part and which allows the driving finger to retract towards the axis of rotation under the action of a radial component of a force exerted on said driving finger; wherein the mechanism is arranged in such a way that the spring contracts when said spring is loaded in order to be able to cause the indicator to subsequently jump; and wherein an angular displacement of the second end of the spring, and thus of the driving finger, relative to the wheel platform, and thus to the first end of the spring, is limited, when the coil is contracted, by an angular stop attached to the wheel platform for rotation therewith.

2. The horological movement according to claim 1, wherein the indicator and the mechanism are arranged so that a jump by the indicator occurs, in normal operation, after said angular displacement has been stopped by the angular stop, once a loading of the spring preceding said jump has ended, and thus corresponds to a determined angular distance (α).

3. The horological movement according to claim 2, wherein the first end of the spring is connected to a central part which is attached to the wheel platform for rotation therewith.

4. The horological movement according to claim 3, wherein the mechanism comprises a central hub defining the shaft which passes through said opening in the rigid part and guides said rigid part rotatably and translatably, with the wheel platform and the central part being attached to the central hub for rotation therewith.

5. The horological movement according to claim 2, wherein the rigid part is formed by a plate, which extends above the spring and wherein said opening is machined, and an axial wall arranged at the edge of said plate and which slopes down towards the wheel platform, at least a part of the axial wall and a part of the plate, which is stacked thereon, jointly forming the driving finger, which has a height (H) that extends at least from the underside of the spring to the upper surface of the plate.

6. The horological movement according to claim 5, wherein the rigid part forms a drum-finger defining an interior space in which the spring is located.

7. The horological movement according to claim 5, wherein the axial wall has a recess with a lateral opening on the spring side; and wherein the second end of the spring is extended by a member for coupling with the rigid part, said coupling member being configured so as to be able to penetrate at least partially into the recess through the lateral opening and thus allow the spring to apply a force couple to the rigid part and thus allow the driving finger to drive the indicator.

8. The horological movement according to claim 7, wherein the recess and the coupling member are configured so that the contact point or contact zone of the recess, on which point or zone the spring force is exerted, via the coupling member, does not substantially vary when the spring is being loaded.

9. The horological movement according to claim 7, characterised in that wherein the recess and the coupling member are configured such that the coupling member cannot substantially rotate about itself, in the direction of rotation of the wheel platform, when the spring is being loaded.

10. The horological movement according to claim 7, wherein the recess has a lateral surface oriented obliquely in the direction of rotation of the wheel platform, in which direction the indicator is intended to be driven, relative to a radial direction, in the spring loading configuration, passing through the centre of said lateral surface, and the coupling member has a lateral flank, facing the lateral surface, which is also inclined obliquely, relative to said axis of rotation, in the same direction as the lateral surface and which bears at least partially against said lateral surface when the spring is being loaded and when the indicator is being driven to make the next jump.

11. The horological movement according to claim 7, wherein the coupling member has a rear heel for blocking rotation of the coupling member about itself in said direction of rotation of the wheel platform.

12. The horological movement according to claim 1, wherein the indicator is a minute indicator, hour indicator, date indicator, day indicator or month indicator, said indicator comprising a toothing.

13. The horological movement according to claim 2, wherein the indicator is a minute indicator, hour indicator, date indicator, day indicator or month indicator, said indicator comprising a toothing.

14. The horological movement according to claim 12, wherein the indicator is a date ring comprising an internal toothing.

15. The horological movement according to claim 13, wherein the indicator is a date ring comprising an internal toothing.

16. A watch comprising a horological movement according to claim 1.

17. The watch comprising a horological movement according to claim 2.
